(19) United States
(12) Patent Application Publication
(10) Pub. No.: US 2023/0401352 A1
(43) Pub. Date: Dec. 14, 2023

(54) METHOD, SYSTEM AND COMPUTER PROGRAM PRODUCT FOR CAD-KNOWLEDGE MANAGEMENT

(71) Applicant: SPG DRY COOLING BELGIUM SRL, Bruxelles (BE)

(72) Inventors: Andreas COUMNAS, Bruxelles (BE); Christophe DELEPLANQUE, Bruxelles (BE); Sanjeev NARAYANAN, Bruxelles (BE)

(21) Appl. No.: 18/250,430

(22) PCT Filed: Oct. 29, 2021
(86) PCT No.: PCT/EP2021/080137

§ 371 Date: Apr. 25, 2023

(30) Foreign Application Priority Data
Oct. 30, 2020 (BE) 2020/5780

(51) Int. Cl. G06F 30/17

(52) U.S. Cl. CPC G06F 30/17; G06F 2111/04

(57) ABSTRACT

The present invention pertains to a method, system and computer program product for computer-aided design (CAD) knowledge management, as well as use thereof for managing CAD-knowledge models of cooling installations.

### FIELD OF THE INVENTION

The present invention pertains to a method, system and computer program product for computer-aided design (CAD) knowledge management.

### BACKGROUND

CAD has been used to aid in the design and especially the drafting of a part or product. It is both a visual (or drawing) and symbol-based method of communication whose conventions are particular to a specific technical field. Drafting can be done in two and three dimensions.

CAD is mainly used for detailed engineering of 3D models and/or 2D drawings of physical components, but it is also used throughout the engineering process from conceptual design and layout of products, through strength and dynamic analysis of assemblies to definition of manufacturing methods of components.

Furthermore, CAD enables designers to store various design know-how and verification standards in a CAD model and share the model with engineers by making it a template. However, workload is significantly increased when knowledge is changed (e.g., based on new discoveries). This makes it necessary to change not only the template but also all CAD models based on the template.

Systems that make knowledge, which originated from a CAD model, available to other CAD systems and applications are known in the art, e.g. U.S. Pat. No. 2,010,042 658. However, known systems such as described in US '658 have the disadvantage that the knowledge server acts as a source of information, and not as a single source of truth. Moreover, the system described in US '658 is not supported for drawing input from multiple CAD-applications each directed at different parts of a project. Similar systems are also described in Badin et al. 2011, Gomes et al. 2007, US 2007 0174026 and US 2016 299771.

There remains a need in the art for a method, system and computer program product for managing a CAD-knowledge model and especially for improving interaction between different CAD-applications and said CAD-knowledge model. The invention aims to resolve at least some of the technical problems associated with methods, systems and computer program products known in the art.

### SUMMARY OF THE INVENTION

In a first aspect the present invention relates to a computer-implemented method for CAD-knowledge management according to claim 1.

In a second aspect the present invention relates to a computer system for CAD-knowledge management according to claim 13.

In a third aspect the present invention relates to a computer program product for CAD-knowledge management according to claim 14.

In a fourth aspect the present invention relates to use of the invention according to a first, second or third aspect according to claim 15.

The invention is advantageous as it allows for an easy and accurate management of a plurality of diverse CAD-knowledge models. As an extension thereof, projects with teams working on different aspects of said project are also more easily organised, which furthermore results in an improved efficiency. Further advantages of the invention are discussed hereafter throughout the description, examples and figures.

Preferred embodiments of the invention are discussed in claims 2 to 12, as well as throughout the description, examples and figures.

### DESCRIPTION OF FIGURES

FIG. 1 shows a schematic structure of a database according to the invention.

FIGS. 2 and 3 show a schematic overview of an overall workflow of the invention.

### DETAILED DESCRIPTION OF THE INVENTION

The present invention concerns a method, system, computer program product for CAD-knowledge management, and use of the method, system and computer program product for managing CAD-knowledge models of cooling installations. In what follows, the invention will be described in detail, preferred embodiments are discussed and the invention will be illustrated by means of non-limitative examples.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a computer module” refers to one or more than one computer module.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited features, element, steps, etc., known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein. Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In a first aspect, the invention pertains to a computer-implemented method for computer-aided design (CAD) knowledge management. The method preferably comprising the step of providing a database for management of a plurality of CAD-knowledge models. The database preferably comprising, for each CAD-knowledge model, a plurality of input and output data fields. Each of said data field comprising a data slot and a CAD-identifier. The database preferably further comprising, for each CAD-knowledge model, a plurality of calculation modules for transforming values provided to input data slots to values of output data slots. The method preferably further comprising the step of providing a plurality of input values in the input data slots of a CAD-knowledge model, wherein for said input values a corresponding output value is obtained for said knowledge model by means of the calculation modules. The method preferably further comprising the step of providing at least some of the values and corresponding CAD-identifiers comprised by the plurality input and output data slots of said CAD-knowledge model to a CAD-module suitable for generating a parametric three-dimensional CAD-model. The method preferably further comprising the step of obtaining a three-dimensional parametric CAD-model from the provided values of said knowledge model by means of said CAD-module. Preferably, each CAD-identifier from a data field in the database for said knowledge model corresponds to a parameter of a parametric CAD-model. The method preferably further comprising the step of applying a modification to the three-dimensional parametric CAD-model. Preferably, the modification corresponds to a changed parameter of said model. The method preferably further comprising the step of obtaining a value corresponding to the changed parameter on the database. The method preferably further comprising the step of adapting an original value of a data slot in the database to the value corresponding to the changed parameter. Preferably, wherein the data field of said original value has a CAD-identifier corresponding to the changed parameter.

In a second aspect, the invention pertains to a computer system for CAD-knowledge management. The computer system comprising a database for management of a plurality of CAD-knowledge models and a CAD-module suitable for generating a parametric three-dimensional CAD-model. The database preferably comprising for each CAD-knowledge model a plurality of input and output data fields. Preferably, each of said data fields comprising a data slot and a CAD-identifier. The database preferably further comprising for each CAD-knowledge model a plurality of calculation modules for transforming values provided to input data slots to values of output data slots. The computer system preferably being configured for obtaining a plurality of input values in the input data slots of a CAD-knowledge model. Preferably, wherein for said input values a corresponding output value is obtained for said knowledge model by means of the calculation modules. The computer system preferably being configured for providing at least some of the values and corresponding CAD-identifiers comprised by the plurality input and output data slots of said CAD-knowledge model to the CAD-module. The computer system preferably being configured for obtaining a three-dimensional parametric CAD-model from the provided values of said knowledge model by means of said CAD-module. Preferably, wherein each CAD-identifier from a data field in the database of said knowledge model corresponds to a parameter of a parametric CAD-model. The computer system preferably being configured for applying a modification to the three-dimensional parametric CAD-model. Preferably, wherein the modification corresponds to a changed parameter of said model. The computer system preferably being configured for obtaining a value corresponding to the changed parameter on the database. The computer system preferably configured for adapting an original value of a data slot in the database to the value corresponding to the changed parameter. Preferably, wherein the data field of said original value has a CAD-identifier corresponding to the changed parameter.

In a third aspect, the invention pertains to a computer program product for CAD-knowledge management. The computer program product preferably comprising instructions for accessing a database for management of a plurality of CAD-knowledge models. The database preferably comprising for each CAD-knowledge model a plurality of input and output data fields. Each of said data fields preferably comprising a data slot and a CAD-identifier. The database preferably further comprising a plurality of calculation modules for transforming values provided to input data slots to values of output data slots. The computer program product preferably further comprising instructions for providing at least some of the values and corresponding CAD-identifiers comprised by the plurality input and output data slots of said CAD-knowledge model to a CAD-module suitable for generating a parametric three-dimensional CAD-model. The computer program product preferably further comprising obtaining a three-dimensional parametric CAD-model from the provided values of said knowledge model by means of said CAD-module. Preferably, wherein each CAD-identifier from a data field in the database of said knowledge model corresponds to a parameter of a parametric CAD-model. The computer program product preferably further comprising applying a modification to the three-dimensional parametric CAD-model, wherein the modification corresponds to a changed parameter of said model. The computer program product preferably further comprising obtaining a value corresponding to the changed parameter on the database. The computer program product preferably comprising adapting an original value of a data slot in the database to the value corresponding to the changed parameter. Preferably, wherein the data field of said original value has a CAD-identifier corresponding to the changed parameter.

In a fourth aspect, the invention pertains to a use of the invention according to a first, second or third aspect for managing CAD-knowledge models of cooling installations.

The present disclosure provides a computer-implemented method, a computer program product, a computer system, and a use of any of the method, the computer program product, or the computer system for CAD-knowledge management. A person having ordinary skill in the art will appreciate that the computer-implemented method is implemented in the computer program product and executed using the computer system. A person having ordinary skill in the art will also appreciate that any of the method, the computer program product, or the computer system are is suited for managing CAD-knowledge models of cooling installations. In what follows, the four aspects of the present invention are therefore treated together.

“Computer-aided design model” or “CAD-model,” as used herein, comprises computer-processable data, preferably digital data, about one or more solids, said data representing, or allowing to derive, properties of the solids, such as geometric properties, material properties and/or semantic properties. Said data may also represent, or may allow to derive, relative geometric properties between solids.

CAD-model, as used herein, is preferably a parametric CAD-model, which, as used herein, comprises a family of probability distributions that has a finite number of parameters.

A CAD model may be viewed and/or edited via a corresponding CPP, so-called CAD software. A non-limiting list of CAD software comprises 123D, ACIS, Advance Concrete, Advance Design, Advance Steel, AllyCAD, ArchiCAD, AutoCAD, ‘Autodesk Inventor’, ‘AutoCAD Plant 3D’, ‘Autodesk Robot’, BricsCAD, BRL-CAD, C3D, Caddie, Cadwork, CATIA, Chief Architect, Cobalt, Creo, DataCAD, DesignSpark Mechanical, Digital Project, Drawing Express, FINE MEP, form»Z, FreeCAD, HiCAD, InsiteVR, IDEA Architectural, IRONCAD, ItelliCAD, KeyCreator, LibreCAD, MEDUSA, MicroStation, Modelur, NanoCAD, NX, OpenCASCADE, OpenSCAD, Parasolid, PTC Creo, PowerCADD, progeCAD, PunchCAD, QCad, Revit Architecture, Revit MEP, Revit Structure, Rhinoceros 3D, RoutCad, SALOME, ShapeManager, SketchUp, Solid Edge, SolidWorks, SolveSpace, SpaceClaim, SpaceClaim Engineer, Tekla Structures, TopSolid, TransMagic, TurboCAD, VariCAD, VectorWorks, and VisualARQ. A non-limiting list of BIM software comprises Allplan, ArchiCAD, ARCHLine.XP, Autodesk Revit, BricsCAD, CodeBook, DDS-CAD, Digital Project, GRAITEC Advance, IDEA Architectural, MicroStation, Navisworks, OpenStudio, RFEM, Tekla BlMsight, Tekla Structures, Trimble SketchUp, VectorWorks Architect, Vico Office, and VisualARQ.

A CAD model, as used herein, is preferably a “building information model” or “BIM-model”. One of ordinary skill in the art will appreciate that while the present invention preferentially involves a BIM, it may also be used for CAD models in different fields, such as, for example, mechanical engineering. BIM involves representing a design as combinations of “objects,” which are vague and undefined, generic or product-specific, solid shapes or void-space oriented (like the shape of a room), that carry their geometry, relations and attributes. Furthermore, BIM design tools allow extraction of different views from a building model for drawing production and other uses. These different views are automatically consistent, being based on a single definition of each object instance. BIM software also defines objects parametrically; that is, the objects are defined as parameters and relations to other objects, so that if a related object is amended, dependent ones will automatically also change. Moreover, each model element can carry attributes for selecting and ordering them automatically, providing cost estimates as well as material tracking and ordering.

Building information modelling (BIM) is a process involving the generation and management of digital representations of physical and functional characteristics of places. BIMs are files (often but not always in proprietary formats and containing proprietary data) which can be exchanged or networked to support decision-making about a place. Current BIM software is used by individuals, businesses and government agencies who plan, design, construct, operate and maintain diverse physical infrastructures, such as water, wastewater, electricity, gas, refuse and communication utilities, roads, bridges and ports, houses, apartments, schools and shops, offices, factories, warehoused and prisons. Traditional building design was largely reliant upon two-dimensional drawings (plans, elevations, sections, etc.). Building information modelling extends this beyond 3D, augmenting the three primary spatial dimensions (width, height and depth) with time as the fourth dimension and cost as the fifth dimension. BIM therefore covers more than just geometry. It also covers spatial relationships, light analysis, geographic information, quantities and properties of components (for example, manufacturers' details).

A simple embodiment of the present invention provides a database for management of a plurality of CAD-knowledge models. A CAD-knowledge model describing non-limitative a system, operational characteristics thereof, as well as their relation to an environment. By storing such CAD-knowledge model on a database, a central truth of a project can be provided to different teams with different specialties, working on different aspect of a project. A simple embodiment of a CAD-knowledge model comprises a plurality of input and output data fields. Each of said input and output fields comprising a data slot and a CAD-identifier. A data slot is suitable to receive a value, i.e. an input or output value. Input values are preferably provided to data slots by a user. Input values furthermore may or may not be provided (automatically) by a program, via for example a feedback loop. Output values are preferably provided to data slots via one or more calculation modules transforming one or more corresponding input values. Output values furthermore may or may not be provided (automatically) by a program, via for example a feedback loop. A simple embodiment of a CAD-knowledge model furthermore comprises a CAD-identifier associated with a data slot. These identifiers correspond to a parameter of a parametric CAD-model. As such, the values and corresponding identifiers can be imported in a CAD-program or application to therefrom generate a model.

According to a preferred embodiment, a CAD-knowledge model further comprises, for each of the input and output data fields, one or more of a component indicator, a package indicator, a project indicator and a unit associated to the value. In order to maintain overview of a project, such as construction of an industrial plant, each of the input and output data fields are preferably provided with a hierarchical project indicator. Preferably, these hierarchical project indicators refer to a project at a component-, package- and project-level. As such, allowing easy overview of the project. Furthermore, in order to improve readability of the data fields of a knowledge models a unit associated to the value. This unit may serve as improving readability but may also be used to provide a current unit to a CAD-application when importing the values from the database. Alternatively, when importing the values to a CAD-application the units are comprised by the corresponding CAD-identifier.

According to a preferred embodiment, a CAD-knowledge model further comprises, for each of the input and output data fields, a view-indicator. Preferably, the database further comprises an interface module comprising a view selector module. Preferably, wherein depending on each of the view-indicators of the data fields, the view selector module determines which data fields are shown by the interface module. Such implementation improves user-friendliness of the database. For example, depending on the user of the database, different data fields might be shown via the user interface, i.e. a manager working on a project can be shown different data fields compared to a engineer working on a component-level. The user may for example be recognised by means of login-module. Furthermore, this login-module may for example request an identification code, password, etc. Furthermore, depending on each of the view-indicators of the data fields, the view selector module may or may not determine the sequence by which the elements in the data fields are shown by the interface module, or which are or are not shown by the interface.

According to a preferred embodiment, the plurality of calculation modules are provided to the database for a CAD-knowledge model as one or more of a flat file, a structured file, a relational table or an XML data file. Such structured data files are easy to read by an operator and application. After providing these calculation modules to the database, the calculation modules can be stored in an appropriated data format. Preferably, the calculation modules are stored as a “JavaScript Object Notation” (JSON) file on the database. JSON is an open standard file format, and data interchange format, that uses human-readable text to store data objects consisting of attribute-value pairs and array data types (or any serializable value).

According to a preferred embodiment, the plurality of input values are provided in the input data slots of a CAD-knowledge model as one or more of a flat file, a structured file, a relational table or an XML data file.

According to a preferred embodiment, a CAD-knowledge model can be exported from the database as one or more of a flat file, a structured file, a relational table or an XML data file. For example, the model is exported as a data sheet or DNO/report.

A simple embodiment of the present invention furthermore comprises providing at least some of the values comprised by the plurality input and output data slots of said CAD-knowledge model to a CAD-module suitable for generating a parametric three-dimensional CAD-model. “CAD-module,” as used herein, comprises one or more CAD-programs or applications. Any of the examples listed hereabove can thus be comprised by a CAD-module. Preferably, the CAD-module comprises one or more of a CAD-application for mechanical design, a CAD-application for design of structural loads and a CAD-application for process design of plant facilities, a CAD-application for Control and Instrumentation, a CAD-application for Electrical design, or any combinations thereof. Accordingly, the invention may or may not provide one or more of the following applications: ‘Autodesk Inventor’, ‘Autodesk Robot’, ‘AutoCAD’ and ‘AutoCAD Plant 3D’. Other applications or combinations of applications are naturally also applicable to the inventions. Preferably, the one or more CAD-applications of the CAD-module are coupled via a building information modelling (BIM) application. By storing values of such knowledge model in the database, a central truth of a project can be provided to different teams with different specialties, working on different aspect of a project.

According to a preferred embodiment, the input and output data fields of a knowledge model are stored in the database as one or more of a flat file, a structured file, a relational table or an XML data file. Preferably, the input and output data fields of a knowledge model are stored in the database as a flat file. More preferably, wherein each of the input and output data fields of a knowledge model are stored in the database as a table or as a string in a flat file, preferably as a string in a flat file. Even more preferably, wherein elements of a data field in a string of a flat file are separated by means of a separation symbol. Flat files, structured files, etc. are easy to read by both a user and a program. Flat files are particularly advantageous as they follow a uniform format, and there are no structures for indexing or recognizing relationships between records. By providing the different data fields as strings in a flat file, the information is easy to read by a user. Suitable separation symbols include, but are not limited to, logical operators such as ‘=’, ‘≠’, ‘<’, ‘≤’, ‘>’, ‘≥’, or combinations thereof, Boolean operators such as ‘&’, ‘&&’, ‘|’, ‘∥’, or combinations thereof, etc. Preferably, ‘=’ is used as separator. Information stored in the database, e.g. flat file, is used for communication between database and CAD-module. Preferably, said communication occurs trough an API.

A simple embodiment of the present invention furthermore comprises obtaining a three-dimensional parametric CAD-model from the provided values of a knowledge model by means of said CAD-module. In order to match the exported values with the to be create CAD-model, each CAD-identifier from a data field in the database for said knowledge model corresponds to a parameter of a, preferably the, parametric CAD-model. The CAD-module may or may not be provided on a separate computer system as the database. The CAD-module may or may not be provided on the same computer system as the database. Preferably, the database is provided in a database server, more preferably a cloud server. Preferably, the CAD-module is provided in a server in connection, via for example the internet, to said database server. The CAD-module may or may not be provided on different servers, each in connection with said database server. Such configuration allows providing a central truth of a project to different teams with different specialties, working on different aspect of said project.

A simple embodiment of the present invention furthermore comprises applying a modification to the three-dimensional parametric CAD-model. Preferably, wherein the modification corresponds to one or more changed parameters of said model. The modification of the three-dimensional model may or may not be performed by means of user action. Furthermore, the modification may or may not be performed by means of an automated manipulation of the model. Modifications can be applied to any entity of the three-dimensional CAD-model. Specific examples of modifications to the three-dimensional model include, but are not limited by, geometric properties, relative geometrical properties, material properties, semantic property, etc.

“Entity,” as used herein, should to be understood as a graphical element of a CAD drawing or model. Examples are lines, arcs, polylines, circles, ellipses, text, dimensions, leaders, hatches, solids, blocks, etc. The term “polyline” in underlying invention is to be understood as a continuous line composed of one or more line segments (i.e. lines). The term “dimension” in underlying invention is to be understood as a graphical entity which displays the measurement of another entity or set of entities in a CAD drawing. Dimensions can be of various types, linear, aligned, angular, radial, etc. For example, an aligned dimension on a line showing the length between the two points of the line or a radial dimension attached to a circle showing the radius measurement of the circle. The term “leader” in underlying invention is to be understood as a graphical entity that displays some textual notes associated with another entity or set of entities in a drawing. A leader typically has an arrow pointing to the entity(s) that it is displaying the text information for. The term “hatch” in underlying invention is to be understood as a graphical entity that represents a shaded or patterned region on a drawing.

“User action,” as used herein, should to be understood as an operation or command to be performed by the user on one or more entities in a CAD model. Examples are manifold. Also, these user actions can be related to constraints, associations between entities, etc. The term “constraints” in underlying invention is to be understood a set of rules assigning spatial relationships between entities. Constraints can be geometrical or dimensional. E.g. a parallel geometrical constraint when applied between two lines forces the lines to remain parallel, no matter how they are modified (moved, rotated, stretched, etc). A dimensional constraint defined between the centre of a circle and the end point of a line forces those two points to keep the same distance no matter how the line or circle is modified. Dimensional constraints have the added feature of being editable, i.e. modifying the value of the constraint now modifies the entities to achieve the constraint. E.g. changing the distance value described earlier will result in the circle and/or line repositioning itself to satisfy the new value of the constraint. Also, entities in a drawing can be associated with other entities in a drawing. For example, dimensions on a line are said to be associated with the line. If the line is modified, that dimension will be modified automatically. Similarly, if a closed region is hatched, modifying the region will modify the hatch.

A non-limiting list of “geometric properties” of a solid comprises a position; an orientation; a dimension, such as a length, a width, a height, a thickness, a diameter, and the like; an inclination, such as with the vertical axis; a direction of a principal axis; and a radius of curvature. A non-limiting list of “relative geometrical properties” of two solids comprises a relative distance; a relative orientation; a relative position, such as a relative height; a relative angle, such as a relative angle between faces or axes; and a relative size, such as a relative dimension, relative area, or relative volume. A non-limiting list of “material properties” of a solid comprises a material specification or composition; a tensile strength per area; a melting temperature; a price per volume or weight; and a density. A non-limiting example of a “semantic property” of a solid is a function classification, such as wall, roof, beam, bolt, etc.

A simple embodiment of a CAD-knowledge model furthermore comprises obtaining a value corresponding to the changed parameter on the database and adapting the original value of the data slot in the database to the value of the corresponding changed parameter. This implementation provides a two-way communication between the database and the CAD-module. Furthermore, such database-CAD-module configuration allows providing a central truth of a project to different teams with different specialties, working on different aspect of said project.

According to a preferred embodiment, prior to adapting the original value of the data slot in the database to the value of the corresponding changed parameter, the value of the corresponding changed parameter is obtained on an approval module, wherein it is determined on said approval module whether said value meets a source criterium, wherein if said value meets said criterium, the value of the data slot in the database is adapted to the value of the corresponding changed parameter, wherein if said value does not meet said criterium, the value of the data slot in the database is not adapted to the value of the corresponding changed parameter. Accordingly, the single truth on the database is guarded by the approval module.

It should be clear that different branches can use the values on the database. A branch may for example refer to a single team of a group of teams, wherein said team for example works on a specific aspect, e.g. electrical engineering, of a project. Accordingly, approval to adapt an original value in the database is required for each branch. As such, the approval module guards the single truth stored on the database for a CAD-knowledge model. In addition to a single truth overarching different branches, a single truth may be guarded by the approval module for each separate branch. As such, different branches of the CAD-knowledge model can be created.

The source criterium of the approval module may or may not be predefined. An example of a predefined source criterium is a criterium that fills in the to be approved value in an algorithm and compares the therefrom obtained value to a predefined threshold value. A non-predefined example of a source criterium is for example a manual criterium, wherein a user, particularly a moderator, checks the value prior to approving or disapproving said value. A mix of a predefined and non-predefined source criterium is also possible; for example, a criterium wherein a percentage of a group of moderators should determine whether a value should or should not be approved for changing the original value of the data slot in the database.

Data not approved by the approval module for a CAD-knowledge model or a branch thereof may or may not be stored. This unapproved data is not necessarily deleted, and may for example be used as a set of training records for training a computer-implemented machine learning module for providing insights on user desirability. Each of said training records may for example comprise a starting training input value and a corresponding desired training input value which was determined by a user. After training, the computer-implemented machine learning module can be used for transforming a starting input value associated with a data slot and CAD-identifier and inputted in the database to a corresponding output value on the database also associated with a data slot and CAD-identifier data slot.

“Artificial intelligence” or short “AI,” as used herein, refers to a field pertaining to machine mimicking of cognitive functions. The central problems of AI research include reasoning, knowledge, planning, learning, natural language processing, perception, and the ability to manipulate objects. Approaches include statistical methods, computational intelligence, and traditional symbolic AI. The AI field draws upon computer science, mathematics, psychology, linguistics, philosophy, neuroscience, artificial psychology, and many others. Capabilities classified as AI include successfully understanding human speech, competing at a high level in strategic game systems, autonomous cars, intelligent routing in content delivery networks, interpreting complex data, and the like. The AI field encompasses the field of machine learning. A non-limiting list of techniques used in machine learning comprises decision tree learning, association rule learning, artificial neural networks, deep learning, inductive logic programming, support vector machines, clustering, Bayesian networks, reinforcement learning, representation learning, similarity and metric learning, sparse dictionary learning, genetic algorithms, rule-based machine learning, and learning classifier systems. A non-limiting list of software programs and/or libraries used for machine learning includes Apache SINGA, Caffe, Deeplearning4j, Dlib, Keras, Microsoft Cognitive Toolkit, Microsoft Computational Network Toolkit, MXNet, Neural Designer, OpenNN, Pytorch, Scikit-learn for the Python programming language, TensorFlow, Theano, Torch, Wolfram Mathematica.

According to a specific embodiment, the CAD-module comprises or is connected to a virtual reality (VR) module suitable for modifying the three-dimensional parametric CAD-model. Examples of such VR-modules are InsiteVR for BIM360, VR The Wild, etc. Evidently, in light of the present invention, for any modification made to the three-dimensional parametric CAD-model by means of the VR module, a value corresponding to a changed parameter of said modification is obtained on the database, and subsequently triggers adaptation of the value of the data slot in the database to the value of the corresponding changed parameter.

### EXAMPLES AND DESCRIPTION OF FIGURES

The present invention will now be further exemplified with reference to the following examples. The present invention is in no way limited to the given examples or to the embodiments presented in the figures.

### Example 1: Database

The present example pertains to a preferred method for storing information in the database according to the present invention.

As discussed throughout the description, in order for a CAD-knowledge model to be stored in a user-friendly matter, the different data fields of a knowledge model have to be readable for both an operator and an application. Ideally, a flat file is used, wherein the different data fields are stored as strings and wherein the different element in said string are separated by means of a separator symbol, e.g. ‘=’.

An exert of such preferred flat file is shown below.
Staircase_NorthWest_X_Position=Staircase_NorthWest_X_Position=Straircase 1 x position=1960.00000000=mm=218−STAIRCASE;
Staircase_NorthWest_Y_Position=Staircase_NorthWest_Y_Position=Straircase 1 y position=104600=mm=218−STAIRCASE;
Staircase_SouthEast_X_Position=Staircase_SouthEast_X_Position=Straircase 2 x position=122995=mm=218−STAIRCASE;
Primary_Bundle_Top_Head_Mounting_Width=Primary_Bundle_Top_Head_Mounting_Width=Primary_Bundle_Top_Head_Mounting_Width=526.000=mm=215−A-FRAME;
MSD_Diameter_Reduction_LHS_1=MSD_Diameter_Reduction_LHS_1=MSD Diameter Reduction LHS 1=5400=mm=411−MAIN STEAM DUCT;
MSD_Diameter_Reduction_LHS_2=MSD_Diameter_Reduction_LHS_2=MSD Diameter Reduction LHS 2=3800=mm=411−MAIN STEAM DUCT;
MSD_Diameter_Reduction_LHS_3=MSD_Diameter_Reduction_LHS_3=MSD Diameter Reduction LHS 3=2700=mm=411−MAIN STEAM DUCT;

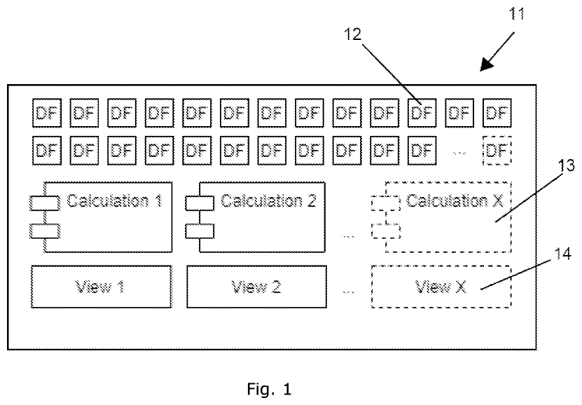

FIG. 1 shows a schematic structure of a database (11) according to the invention, comprising a plurality data fields (12), calculation modules (13), and views (14). In accordance with the above exert, each data field comprises an internal code, a CAD-identifier, a description, a value, a unit associated with the value and a component name, respectively, each separated by means of an ‘=’ as separator symbol. Strings in the flat file are separated by means of an ‘;’. The view-indicator can be based of any of the above elements. The view selector module determines which of the views are shown by the interface-module. The views can be predetermined.

### Example 2: Generic Workflow

The present example pertains to a generic overview of the method, system and computer program product according to the present invention.

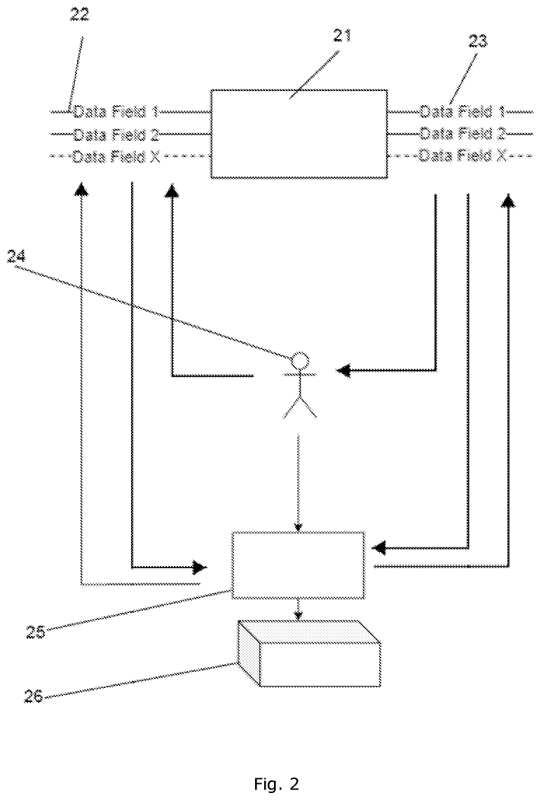

FIG. 2 shows a schematic overview of an overall workflow of the invention. A database (21) is shown, wherein both the input data fields (22) and the output data fields (23) are illustrated to the left and right of the database, respectively. In order for a user (24) to obtain the desired balance between the input and output data fields, he/she may for example interpret the generated output data fields to thereafter manipulate the corresponding input data fields. Furthermore, both the input and output data fields can be imported by a CAD-module (25). According to the present example, the CAD-module comprises a multitude of CAD applications (e.g. AutoCAD, Inventor, etc.), all suitable for generating a parametric three-dimensional CAD-model (26). According to the present invention, any modification applied to said CAD-model triggers modification of the value of the data slot in the database to the value of the corresponding changed parameter in the model. Ideally, an approval module is also provided in said feedback loop to guard the single truth.

### Example 3: Implemented Workflow

The present example pertains to an implemented overview of the method, system and computer program product according to the present invention.

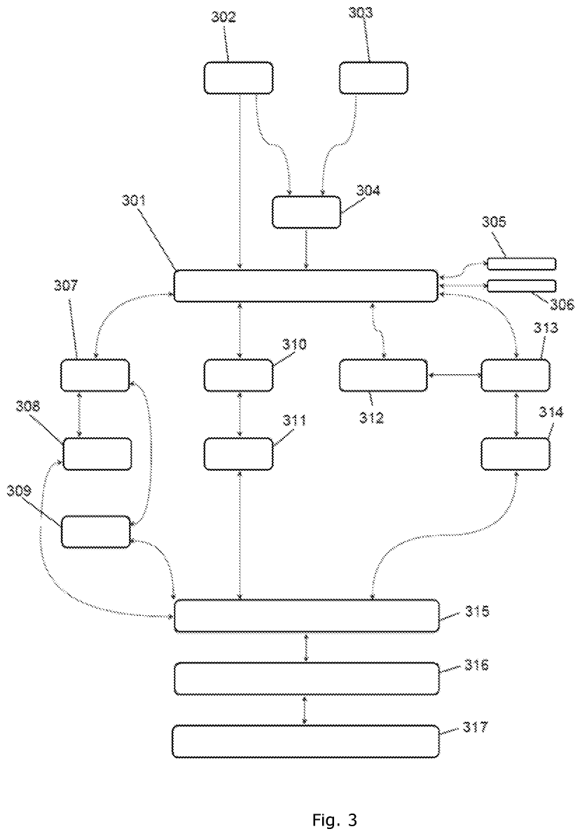

FIG. 3 shows a schematic overview of an implemented workflow of the invention. Central in the overview, the database (301) is drawn. The input and output data fields comprised by said database are obtained by converting excel-information to a flat file. According to the present example, a thermal program (302), e.g. excel file with proprietary calculations, and a proposal datasheet (303), e.g. several excel files delivered by customers, are combined and converted to a flat file. Alternatively, or in addition, the thermal program with calculation can be provided directly to the database, wherein each of said calculations can be added as a module for transforming certain input data fields to output data fields. Furthermore, data comprised in the database can be exported, e.g. data sheet (305) or DNO/report (306), in the same or different format as it was imported, flat file, customized excel file or customized PDF report, etc.

FIG. 3 furthermore shows three sections, each directed at integration of the database with a different CAD-application. A first section shows a connection to ‘Autodesk Inventor’ (307) from which a duct layout (308) and a mechanical equipment layout (309) can be derived. A second section shows a connection to ‘Autodesk Robot’ (310) from which a steel layout (311) can be derived. A third sections shows a connection to both ‘AutoCAD’ (312) and ‘AutoCAD Plant 3D’ (313), that are both integrated, and from which a piping layout (314) can be derived. All of the duct, mechanical equipment, steel and piping layouts are furthermore integrated with building information models such as ‘Navisworks BIM’ (315) and ‘BIM360’ (316). Additionally, one or more CAD-applications may also be connected to a virtual reality (VR) module, such as a connection InsiteVR (317) for BIM360.

### Example 4: Branched Knowledge Model

The present example pertains to an embodiment wherein a single CAD-knowledge model has multiple branches. Each branch operated by a different team.

The knowledge model is stored on a database and comprises a plurality of input and output data fields, each comprising a data slot and a CAD-identifier, and a plurality of calculation modules for transforming values of input data slots to values of output data slots. Particularly, the knowledge model is directed at a cooling installation.

The CAD-identifiers of the knowledge model correspond to parameters of multiple CAD-applications, including a CAD-application for mechanical design, a CAD-application for design of structural loads, a CAD-application for process design of plant facilities, a CAD-application for Control and Instrumentation, and a CAD-application for Electrical design. The different teams of the present example each use a single of the multiple CAD-application. It should, however, be noted, that such configuration is not a prerequisite, and a mere example of the present invention. Moreover, it is clear that different combinations of teams using different CAD-applications are possible within the scope of the present invention.

The CAD-knowledge model of the present example comprises an overarching single truth, as well as a separate single truth for each of the different branches, i.e. teams. Accordingly, the approval module also comprises a separate criterium in the approval module for the overarching single truth as well as for each of the different branches. According to the present example, the single truth of each of the branches is a predefined criterium, wherein if a value does not exceed a predefined threshold value, said value replaces an original value. Furthermore, according to the present example, the overarching single truth is a manual criterium, wherein an operator approves only a single value from the different branches to replace an original value.

The values rejected by the approval module are not deleted. Instead, these values are used in training a computer-implemented machine learning module for providing insights on user desirability. Each of said training records comprises a starting training input value and corresponding desired training input value which was determined by a user, e.g. one of the teams. Despite such values not being selected as a single truth for a CAD-knowledge model, these values are still useful in training a computer-implemented machine learning module for providing insights on user desirability in a global system.

The present invention is in no way limited to the embodiments described in the examples and/or shown in the figures. On the contrary, methods according to the present invention may be realized in many different ways without departing from the scope of the invention.

1. Computer-implemented method for computer-aided design (CAD) knowledge management, comprising the steps of:
providing a database for management of a plurality of CAD-knowledge models, the database comprising for each CAD-knowledge model a plurality of input and output data fields, each comprising a data slot and a CAD-identifier, and a plurality of calculation modules for transforming values provided to input data slots to values of output data slots, which calculation modules are provided to the database for a CAD-knowledge model as one or more of a flat file, a structured file, a relational table file or an XML data file and which calculation modules are stored as a JSON file on the database;
providing a plurality of input values in the input data slots of a CAD-knowledge model, wherein for said input values a corresponding output value is obtained for said knowledge model by means of the calculation modules; providing at least some of the values and corresponding CAD-identifiers comprised by the plurality input and output data slots of said CAD-knowledge model to a CAD-module suitable for generating a parametric three-dimensional CAD-model;
obtaining a three-dimensional parametric CAD-model from the provided values of said knowledge model by means of said CAD-module, wherein each CAD-identifier from a data field in the database for said knowledge model corresponds to a parameter of a parametric CAD-model;
applying a modification to the three-dimensional parametric CAD-model, wherein the modification corresponds to a changed parameter of said model;
obtaining a value corresponding to the changed parameter on the database;
adapting an original value of a data slot in the database to the value corresponding to the changed parameter, wherein the data field of said original value has a CAD-identifier corresponding to the changed parameter.

2. The method according to claim 1, wherein prior to adapting the original value of the data slot in the database to the value corresponding to the changed parameter, the value of the corresponding changed parameter is obtained on an approval module, wherein it is determined on said approval module whether said value meets a source criterium, wherein if said value meets said criterium, the value of the data slot in the database is adapted to the value of the corresponding changed parameter, wherein if said value does not meet said predefined source criterium, the value of the data slot in the database is not adapted to the value of the corresponding changed parameter.

3. The method according to claim 1, wherein the input and output data fields of a knowledge model are stored in the database as one or more of a flat file, a structured file, a relational table file or an XML data file.

4. The method according to claim 1, wherein each of the input and output data fields of a knowledge model are stored in the database as a table or as a string in a flat file, preferably as a string in a flat file, more preferably wherein elements of a data field in a string of a flat file are separated by means of a separation symbol.

5. The method according to claim 1, wherein the CAD-module comprises one or more of a CAD-application for mechanical design, a CAD-application for design of structural loads, a CAD-application for process design of plant facilities, a CAD-application for Control and Instrumentation, a CAD-application for Electrical design, or any combinations thereof.

6. The method according to claim 1, wherein the CAD-module comprises one or more CAD-applications, wherein the one or more CAD-applications of the CAD-module are coupled via a building information modelling (BIM) application.

7. The method according to claim 1, wherein the plurality of input values are provided in the input data slots of a CAD-knowledge model as one or more of a flat file, a structured file, a relational table file or an XML data file.

8. The method according to claim 1, wherein the database further comprises an interface module comprising a view selector module, wherein each of the input and output data fields further comprise a view-indicator, wherein depending on each of the view-indicators of the data fields, the view selector module determines which data fields are shown by the interface module.

9. The method according to claim 1, wherein each of the input and output data fields further comprise one or more of a component indicator, a package indicator, a project indicator and a unit associated to the value.

10. The method according to claim 1, wherein a CAD-knowledge model can be exported from the database as one or more of a flat file, a structured file, a relational table file or an XML data file.

11. Computer system for computer-aided design (CAD) knowledge management, comprising a database for management of a plurality of CAD-knowledge models and a CAD-module suitable for generating a parametric three-dimensional CAD-model, wherein the database comprises for each CAD-knowledge model a plurality of input and output data fields, each comprising a data slot and a CAD-identifier, and a plurality of calculation modules for transforming values provided to input data slots to values of output data slots, wherein the computer system is configured for:
obtaining a plurality of input values in the input data slots of a CAD-knowledge model, wherein for said input values a corresponding output value is obtained for said knowledge model by means of the calculation modules; providing at least some of the values and corresponding CAD-identifiers comprised by the plurality input and output data slots of said CAD-knowledge model to the CAD-module;
obtaining a three-dimensional parametric CAD-model from the provided values of said knowledge model by means of said CAD-module, wherein each CAD-identifier from a data field in the database of said knowledge model corresponds to a parameter of a parametric CAD-model;
applying a modification to the three-dimensional parametric CAD-model, wherein the modification corresponds to a changed parameter of said model;
obtaining a value corresponding to the changed parameter on the database;
adapting an original value of a data slot in the database to the value corresponding to the changed parameter, wherein the data field of said original value has a CAD-identifier corresponding to the changed parameter.

12. Computer program product for computer-aided design (CAD) knowledge management, comprising instructions for:
accessing a database for management of a plurality of CAD-knowledge models, the database comprising for each CAD-knowledge model a plurality of input and output data fields, each comprising a data slot and a CAD-identifier, and a plurality of calculation modules for transforming values provided to input data slots to values of output data slots;
providing at least some of the values and corresponding CAD-identifiers comprised by the plurality input and output data slots of said CAD-knowledge model to a CAD-module suitable for generating a parametric three-dimensional CAD-model;
obtaining a three-dimensional parametric CAD-model from the provided values of said knowledge model by means of said CAD-module, wherein each CAD-identifier from a data field in the database of said knowledge model corresponds to a parameter of a parametric CAD-model;
applying a modification to the three-dimensional parametric CAD-model, wherein the modification corresponds to a changed parameter of said model;
obtaining a value corresponding to the changed parameter on the database;
adapting an original value of a data slot in the database to the value corresponding to the changed parameter, wherein the data field of said original value has a CAD-identifier corresponding to the changed parameter.

13. The use of the computer-implemented method according to claim 1 for managing CAD-knowledge models of cooling installations.

14. The use of the computer system according to preceding claim 11 for managing CAD-knowledge models of cooling installations.

15. The use of the computer program product according to preceding claim 12, for managing CAD-knowledge models of cooling installations.
